(19) United States
(12) Patent Application Publication
(10) Pub. No.: US 2019/0152361 A1
(43) Pub. Date: May 23, 2019

(54) SEAT RUBBER

(71) Applicants: SUMITOMO RIKO COMPANY LIMITED, Komaki-shi (JP); HONDA MOTOR CO., LTD., Tokyo (JP)

(72) Inventors: Toru MATSUSHITA, Komaki-shi (JP); Ruozhou WANG, Komaki-shi (JP); Daisuke SUZUKI, Wako-shi (JP); Kenichi HIBINO, Wako-shi (JP)

(73) Assignees: SUMITOMO RIKO COMPANY LIMITED, Komaki-shi (JP); HONDA MOTOR CO., LTD., Tokyo (JP)

(21) Appl. No.: 16/131,241

(22) Filed: Sep. 14, 2018

(30) Foreign Application Priority Data
Nov. 23, 2017 (JP) 2017-225277

(51) Int. Cl. B60N 2/54

(52) U.S. Cl. CPC B60N 2/542; F16M 13/02

(57) ABSTRACT

A seat rubber mounted onto a suspension component including: an outer peripheral plate-shaped part extending along a receiving part of the suspension to receive a coil spring; an annular curving part defined by a radially inner portion of the outer peripheral plate-shaped part rising along a riser part of the suspension; a center projecting part inserted into a positioning hole of the suspension while being positioned inside the outer peripheral plate-shaped part and projecting from a distal end of the curving part toward its proximal end; an annular groove provided between the curving part and the center projecting part while receiving the riser part; and a flat-plate shaped reinforcing member embedded in the outer peripheral plate-shaped part around the riser part outwardly away from the curving part so as to disperse and transmit an input from the coil spring to the receiving part.

### INCORPORATED BY REFERENCE

The disclosure of Japanese Patent Application No. 2017-225277 filed on Nov. 23, 2017 including the specification, drawings and abstract is incorporated herein by reference in its entirety.

### BACKGROUND OF THE INVENTION

### 1. Field of the Invention

The present invention relates to a seat rubber adapted to be overlapped on a suspension component and to receive a coil spring in cushioned fashion.

### 2. Description of the Related Art

Conventionally, there is known a seat rubber adapted to cover a receiving part of a suspension component that supports the axial end of a coil spring, and to receive the coil spring in cushioned fashion in a suspension mechanism. Whereas the seat rubber may be formed of rubber only, for example, Japanese Unexamined Patent Publication No. JP-A-2005-220976 discloses a spring seat rubber including a rubber main body in which a first fitting and a second fitting are embedded and bonded so as to tune spring characteristics.

Meanwhile, during driving, for example, due to irregularities or the like on the road surface, the coil spring undergoes extension/contraction, so that the input from the coil spring is transmitted to the suspension component via the seat rubber. By the seat rubber undergoing elastic deformation in response to the input, cushioning action owing to the seat rubber will be exhibited between the receiving part of the suspension component and the coil spring.

However, there may be a case in which the suspension component or the seat rubber gets damaged during the input depending on the size of the load. In particular, when the input from the coil spring is transmitted locally to the suspension component via the seat rubber, the suspension component may be damaged due to the localized heavy load. As a specific example, with the seat rubber described in JP-A-2005-220976, when the position of the first fitting deviates with respect to the mated convex part in the radial direction or the like, the first fitting and the mated convex part may locally approach each other on the circumference. This may cause the force to be concentratedly transmitted, posing a risk of damaging the mated convex part.

### SUMMARY OF THE INVENTION

It is therefore one object of this invention to provide a seat rubber of novel structure which is allowed to be stably positioned at an appropriate position with respect to the suspension component, while being able to efficiently disperse the input from the coil spring so as to prevent damage to the suspension component due to concentration of the load.

The above and/or optional objects of this invention may be attained according to at least one of the following modes of the invention. The following modes and/or elements employed in each mode of the invention may be adopted at any possible optional combinations.

Specifically, a first mode of the present invention provides a seat rubber configured to be mounted onto a suspension component, the suspension component including a receiving part of a coil spring, a positioning hole provided to a center of the receiving part, and a riser part being defined by a peripheral edge portion of the positioning hole gradually curving and rising in an annular shape toward an inside of the coil spring, while the seat rubber being configured to be overlapped on the receiving part and to receive the coil spring in cushioned fashion, the seat rubber comprising: an outer peripheral plate-shaped part configured to extend along a surface of the receiving part and to receive an axial end of the coil spring; an annular curving part defined by a radially inner portion of the outer peripheral plate-shaped part being configured to curve and rise along a surface of the riser part; a center projecting part configured to be inserted into the positioning hole, the center projecting part being positioned radially inside the outer peripheral plate-shaped part and projecting from a rising distal end portion of the annular curving part toward a proximal end side thereof; an annular groove provided between the annular curving part and the center projecting part while being configured to receive the riser part; and a reinforcing member embedded and placed in the outer peripheral plate-shaped part with a flat-plate shape configured to be positioned around the riser part in a region away from the annular curving part to an outer peripheral side such that the reinforcing member disperses and transmits an input from the coil spring to the receiving part of the suspension component.

With the seat rubber of construction according to the above first mode, by the riser part of the suspension component being inserted into the annular groove formed between the annular curving part and the center projecting part, the seat rubber is more firmly positioned with respect to the suspension component. Therefore, variability in mounting position of the seat rubber with respect to the suspension component is less likely to occur, and even during the input of heavy load, deviation of the mounting position of the seat rubber is prevented. This makes it possible to prevent the force, which is transmitted from the coil spring to the suspension component, from locally becoming large due to deviation of the mounting position of the seat rubber. As a result, damage to the suspension component caused by stress concentration or the like will be avoided.

Besides, owing to the reinforcing member bonded to the outer peripheral plate-shaped part of the seat rubber that is configured to be overlapped on the receiving part of the suspension component, the input from the coil spring will be dispersed and transmitted over a wider area of the receiving part of the suspension component. Thus, the input from the coil spring will be prevented from locally acting on the suspension component, thereby avoiding damage to the suspension component.

Moreover, the reinforcing member is embedded and placed in the region away from the annular curving part of the seat rubber to the outer peripheral side, and is disposed so as to be positioned around the riser part of the suspension component. With this configuration, the reinforcing member will not be too close to or interfere with the riser part, so that no localized heavy load will be transmitted to the suspension component. Furthermore, since the reinforcing member has a flat-plate shape, even if the position of the reinforcing member somewhat deviates in the planar direction due to elastic deformation of the seat rubber, for example, the force transmitted to the suspension component will be effectively dispersed.

A second mode of the present invention provides the seat rubber according to the first mode, wherein in a portion of the outer peripheral plate-shaped part configured to be contacted by the axial end of the coil spring, the reinforcing member is embedded at a position that is closer to a surface configured to be overlapped on the receiving part than a surface configured to be on a side of the coil spring in a thickness direction of the outer peripheral plate-shaped part.

According to the second mode, in the seat rubber, the rubber layer on the side of the coil spring from the reinforcing member is made thicker. Thus, the input from the coil spring will be exerted on the reinforcing member while being dispersed and moderated by such rubber layer. This may improve the load bearing capability of the reinforcing member, thereby lowering the required deformation rigidity.

Meanwhile, in the seat rubber, the rubber layer on the side of the receiving part from the reinforcing member is made thinner. This makes it possible to stably transmit the acting force that is dispersed throughout roughly the entire surface of the reinforcing member to the receiving part of the suspension component while the rigidity of the reinforcing member is supported by the receiving part. Besides, by the rubber layer on the side of the receiving part from the reinforcing member being made thinner in the seat rubber, concentration of the transmission force due to inclination of the reinforcing member or the like with respect to the receiving part can be avoided.

A third mode of the present invention provides the seat rubber according to the first or second mode, wherein the outer peripheral plate-shaped part includes a contact face configured to be contacted by the axial end of the coil spring, and a radially inner end of the reinforcing member is greater than a radially inner end of the contact face and is smaller than an outer peripheral end of the contact face.

According to the third mode, the reinforcing member is arranged at a position away from the annular curving part to the outer periphery, while the acting force from the coil spring will be effectively exerted on the radially inner end of the reinforcing member. Thus, the acting force from the coil spring will be stably transmitted to the receiving part of the suspension component while being dispersed by the reinforcing member.

With the present invention, by the riser part of the suspension component being inserted in the annular groove of the seat rubber, the seat rubber is positioned with respect to the suspension component. This makes it possible to prevent the force, which is transmitted from the coil spring to the suspension component, from locally becoming large due to deviation of the position of the seat rubber. Additionally, the reinforcing member of flat-plate shape bonded to the outer peripheral plate-shaped part of the seat rubber that is configured to be overlapped on the receiving part of the suspension component will disperse and transmit the input from the coil spring over a wider area of the receiving part of the suspension component. Moreover, the reinforcing member is embedded and placed in the region away from the annular curving part of the seat rubber to the outer peripheral side. With this configuration, the reinforcing member will not interfere with the riser part, so that no localized heavy load will be transmitted to the suspension component.

### BRIEF DESCRIPTION OF THE DRAWINGS

The foregoing and/or other objects, features and advantages of the invention will become more apparent from the following description of an embodiment with reference to the accompanying drawings in which like reference numerals designate like elements and wherein:

FIG. 1 is a cross sectional view of a seat rubber according to a first embodiment of the present invention in a mounted state onto a vehicle, taken along line 1-1 of FIG. 3;

FIG. 2 is a perspective view of the seat rubber shown in FIG. 1;

FIG. 3 is a top plan view of the seat rubber shown in FIG. 1;

FIG. 4 is a bottom plan view of the seat rubber shown in FIG. 1;

FIG. 5 is a front view of the seat rubber shown in FIG. 1;

FIG. 6 is a cross sectional view taken along line 6-6 of FIG. 3;

FIG. 7 is a cross sectional view taken along line 7-7 of FIG. 3;

FIG. 8 is a perspective view of a reinforcing member constituting the seat rubber shown in FIG. 1;

FIG. 9 is a top plan view of the reinforcing member shown in FIG. 8; and

FIG. 10 is a front view of the reinforcing member shown in FIG. 8.

### DETAILED DESCRIPTION OF EMBODIMENTS

An embodiment of the present invention will be described below in reference to the drawings.

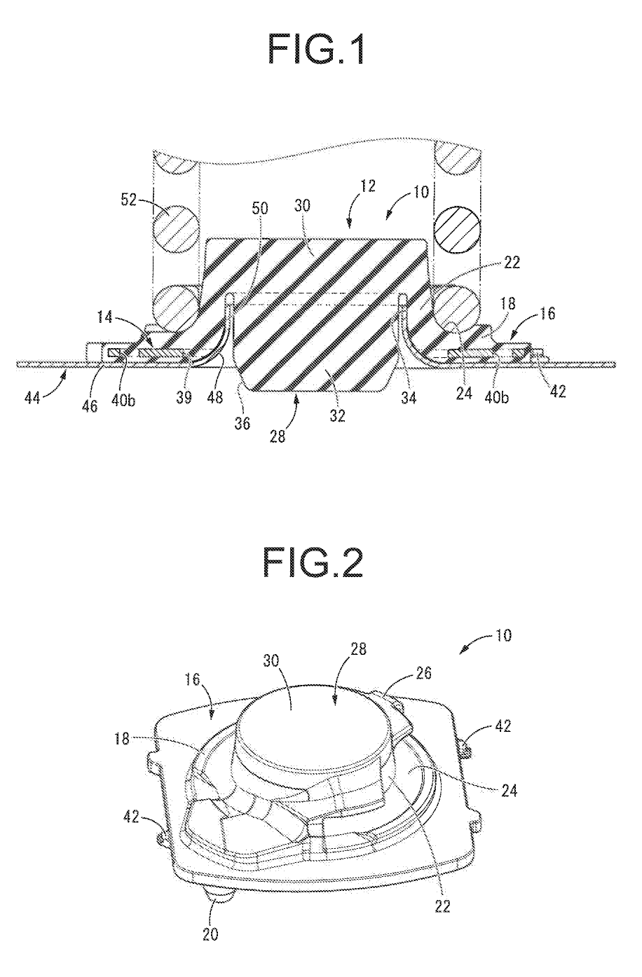

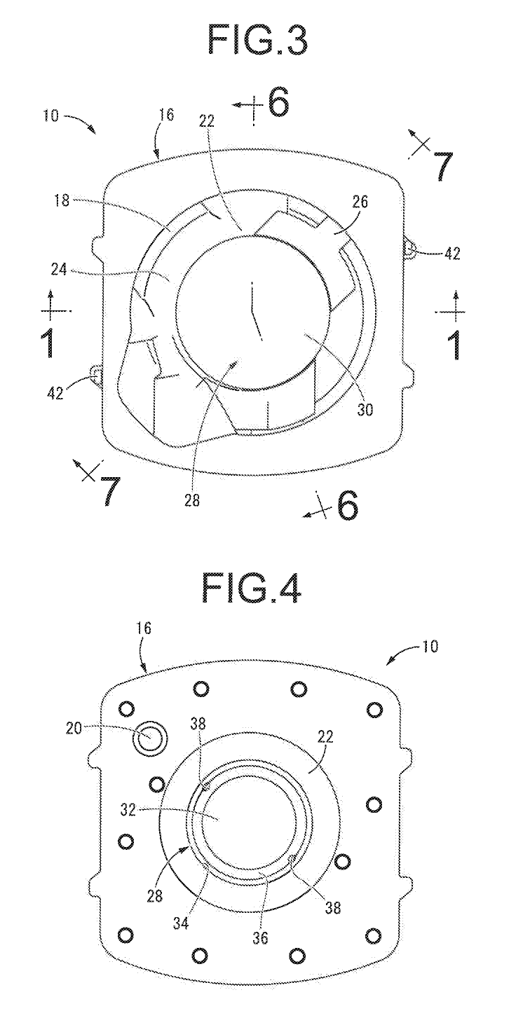

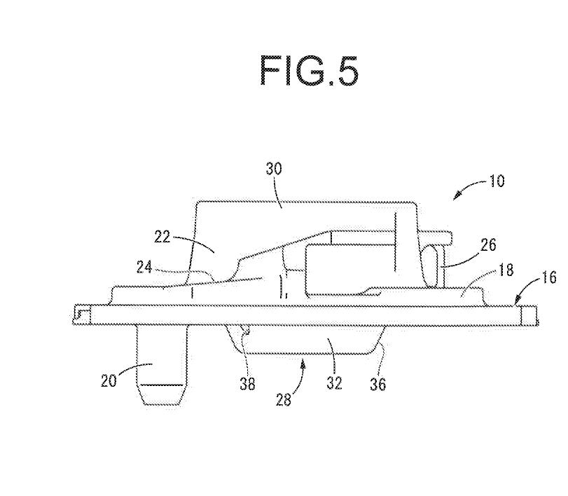

FIG. 1 depicts a seat rubber 10 according to a first embodiment of the present invention in a mounted state onto a vehicle. As shown in FIGS. 2 through 7, the seat rubber 10 comprises a rubber main body 12 and a reinforcing member 14 bonded to the rubber main body 12 in an embedded state. In the description hereinbelow, as a general rule, the vertical direction refers to the vertical direction in FIG. 5, the lateral direction refers to the lateral direction in FIG. 3, and the front-back direction refers to the vertical direction in FIG. 3.

Described more specifically, the rubber main body 12 includes an outer peripheral plate-shaped part 16 at its outer peripheral portion. The outer peripheral plate-shaped part 16 has a ring plate shape in which its outer periphery is an approximate quadrangle while its radial inside is an approximate circle, and the portion configured to receive a coil spring 52 described later constitutes a thick-walled support part 18. A positioning pin 20 projecting downward is integrally formed with a portion in the circumferential direction of the outer peripheral plate-shaped part 16.

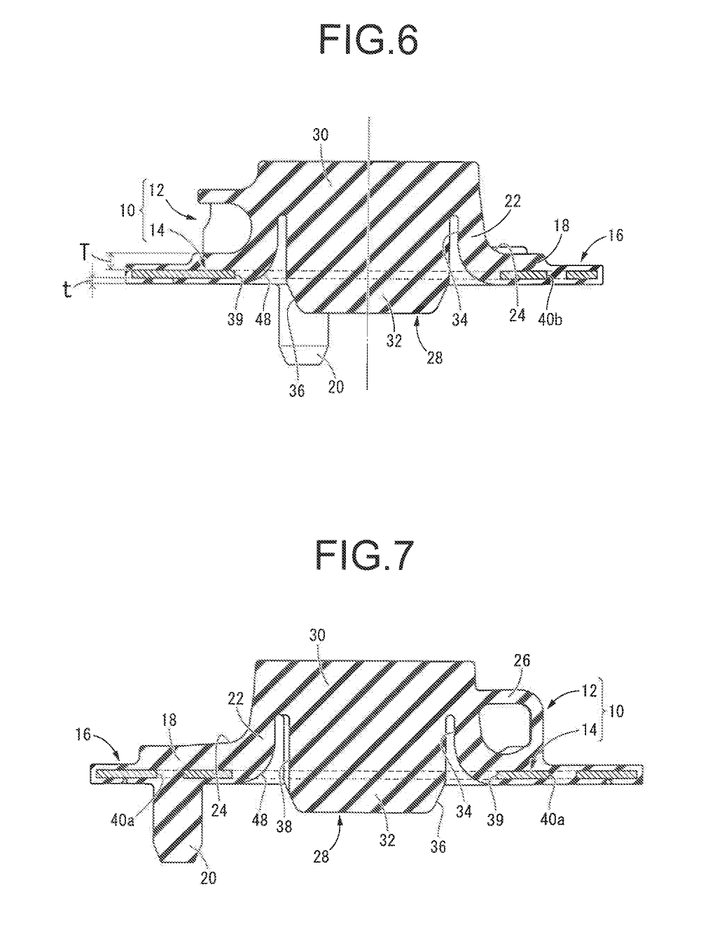

An annular curving part 22 is provided to the radially inner portion of the outer peripheral plate-shaped part 16 of the rubber main body 12. As shown in FIGS. 6 and 7, the annular curving part 22 has a cross sectional shape that curves so as to slope upwardly toward its radial inside, and its rising distal end portion, which is the radially inner end of the annular curving part 22, has a tubular shape extending roughly vertically. Moreover, the upper face of the support part 18 and the upper face of the outer peripheral portion of the annular curving part 22 constitute a contact face 24 configured to be contacted by the axial end of the coil spring 52 described later. A band part 26 is integrally formed with a portion in the circumferential direction of the rubber main body 12 so as to extend from the upper portion of the annular curving part 22 toward the outer periphery and to be connected to the outer peripheral end of the support part 18.

A center projecting part 28 is integrally formed with the radial inside of the outer peripheral plate-shaped part 16 of the rubber main body 12. The center projecting part 28 includes a base portion 30 of generally circular disk shape extending radially inward from the rising distal end portion of the annular curving part 22, and an insertion protrusion 32 of generally cylindrical shape projecting downward from the inner circumferential portion of the base portion 30, so as to project from the rising distal end portion of the annular curving part 22 toward the proximal end side thereof overall. Moreover, the outer circumferential surface of the insertion protrusion 32 is made smaller in diameter than the rising distal end portion of the annular curving part 22 so as to be remote radially inward therefrom by a prescribed distance. Accordingly, between the annular curving part 22 and the insertion protrusion 32, there is formed an annular groove 34 opening downward and extending continuously about the entire circumference in the circumferential direction. With the insertion protrusion 32 in the present embodiment, the outer circumferential surface of the projecting distal end portion constitutes a guiding face 36 of tapered contours becoming smaller in diameter downwardly. Also, on the outer circumferential surface of the insertion protrusion 32, there are formed slots 38 extending in the direction of projection.

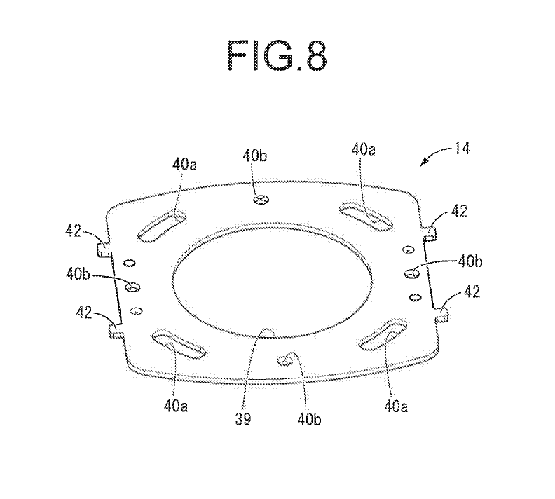

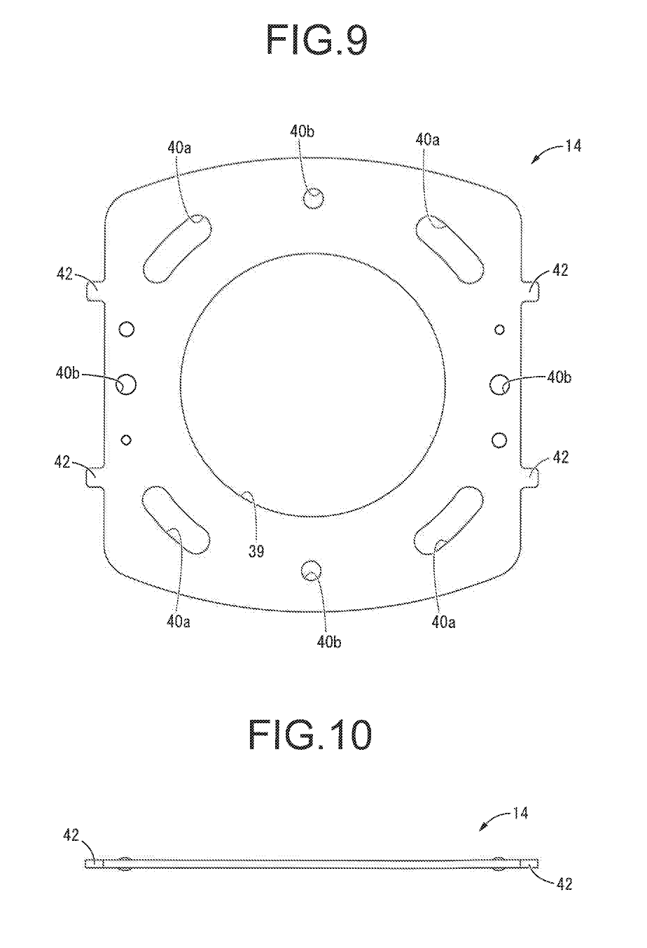

Meanwhile, the reinforcing member 14 has a shape that corresponds to the outer peripheral plate-shaped part 16 of the rubber main body 12. As shown in FIGS. 8 through 10, the reinforcing member 14 has a ring plate shape in which its outer periphery is an approximate quadrangle while its radial inside is an approximate circle, and includes an inner hole 39 that perforates its center portion in the thickness direction (vertical direction). Also, the reinforcing member 14 has a roughly flat-plate shape overall, and in particular, the radially inner portion configured to receive the coil spring 52 described later has a flat shape without any irregularities or holes. The reinforcing member 14 of the present embodiment includes a plurality of through holes 40a, 40b in the outer peripheral portion thereof. Specifically, four through holes 40a of elongated slot shape are provided along the circumferential direction, and through holes 40b of circular shape are provided circumferentially between the through holes 40a. The reinforcing member 14 further includes a plurality of support pieces 42 projecting laterally outward, and during vulcanization molding of the rubber main body 12 described later, the reinforcing member 14 set in the mold for vulcanization molding is configured to be supported by the mold for vulcanization molding at the support pieces 42.

The reinforcing member 14 is bonded to the rubber main body 12. Specifically, the reinforcing member 14 is bonded to the outer peripheral plate-shaped part 16 of the rubber main body 12 in an embedded state, and disposed in the region away from the annular curving part 22 to the outer peripheral side in the rubber main body 12. In the present embodiment, the rubber main body 12 takes the form of an integrally vulcanization molded component incorporating the reinforcing member 14, and the rubber main body 12 and the reinforcing member 14 are bonded by vulcanization. Besides, the rubber main body 12 is molded while being inserted into the through holes 40a, 40b. Accordingly, the adherence strength of the rubber main body 12 and the reinforcing member 14 can be largely obtained, thereby preventing separation between the rubber main body 12 and the reinforcing member 14 or the like. As shown in FIG. 4, the rubber main body 12 includes a plurality of holes formed by the lower face of the reinforcing member 14 being supported by the mold for vulcanization molding.

Moreover, as shown in FIG. 6, the reinforcing member 14 is arranged at the vertically middle portion of the outer peripheral plate-shaped part 16. With the support part 18 of the outer peripheral plate-shaped part 16, the vertical thickness dimension T of the upper side portion from the reinforcing member 14 is made larger than the vertical thickness dimension t of the lower side portion from the reinforcing member 14. In other words, in the support part 18 of the outer peripheral plate-shaped part 16, the reinforcing member 14 is arranged at the position that is closer to the lower face, which is the surface configured to be overlapped on a receiving part 46 of a suspension component 44 described later, than the upper face, which is the surface configured to be on the side of the coil spring 52 described later. In the present embodiment, in the support part 18 of the outer peripheral plate-shaped part 16, the vertical thickness dimension t of the lower side portion from the reinforcing member 14 is made approximately constant about the entire circumference, while the vertical thickness dimension T of the upper side portion from the reinforcing member 14 changes in the circumferential direction. The minimum value of the vertical thickness dimension T of the upper side portion from the reinforcing member 14 is made greater than the vertical thickness dimension t of the lower side portion from the reinforcing member 14. In the outer peripheral end of the outer peripheral plate-shaped part 16, which is away from the support part 18 to the outer peripheral side, the reinforcing member 14 is arranged at the roughly center in the vertical direction.

Furthermore, the edge of the opening of the inner hole 39, which is the radially inner end of the reinforcing member 14, is greater than the radially inner end of the contact face 24 provided to the upper faces of the support part 18 and the annular curving part 22 of the rubber main body 12, and is smaller than the outer peripheral end of the contact face 24. That is, with respect to the contact face 24 of the rubber main body 12, the radially inner end of the reinforcing member 14 is positioned outside the radially inner end of the contact face 24 while being positioned radially inside the outer peripheral end of the contact face 24. With this configuration, as viewed in the vertical direction, the reinforcing member 14 overlaps the outer peripheral portion of the contact face 24 constituted by the upper face of the outer peripheral plate-shaped part 16. On the other hand, as viewed in the vertical direction, the reinforcing member 14 does not overlap the radially inner portion of the contact face 24 constituted by the upper face of the annular curving part 22 but is arranged away therefrom to the outer peripheral side.

The seat rubber 10 of the above construction is mounted on the suspension component 44 provided to a vehicle body, as shown in FIG. 1.

The suspension component 44 is a high rigidity component made of metal or the like and includes an annular receiving part 46. The receiving part 46 has a ring plate shape including a positioning hole 48 of generally circular shape at its center, and is flat-plate shaped so as to extend roughly orthogonally to the vertical direction.

Additionally, a riser part 50 is integrally formed with the radial inside of the receiving part 46 of the suspension component 44. The riser part 50 has a structure in which the peripheral edge portion of the positioning hole 48 provided to the receiving part 46 gradually curves and rises in an annular shape toward the inside of the coil spring 52 described later. In other words, the riser part 50 has a curving cross section that upwardly slopes toward the radial inside with its slope angle becoming larger toward the radial inside, and projects upward at the radial inside of the receiving part 46. The riser part 50 is formed by, for example, the peripheral edge portion of a circular hole provided to a plate member being raised through a process such as burring.

Then, the seat rubber 10 is overlapped and mounted onto the suspension component 44. Specifically, the outer peripheral plate-shaped part 16 of seat rubber 10 is overlapped in a state of contact on the receiving part 46 of the suspension component 44 from above, whereby the seat rubber 10 is mounted onto the suspension component 44. With the seat rubber 10 mounted onto the suspension component 44, the outer peripheral plate-shaped part 16 of the seat rubber 10 is disposed so as to extend along the upper face of the receiving part 46 of the suspension component 44.

Moreover, with the seat rubber 10 mounted onto the suspension component 44, the annular curving part 22 of the seat rubber 10 is overlapped by being placed externally on the riser part 50 of the suspension component 44. Accordingly, the annular curving part 22 curves and rises along the riser part 50, while the center projecting part 28 of the seat rubber 10 is inserted in the positioning hole 48 of the suspension component 44. With these arrangements, the riser part 50 of the suspension component 44 is inserted in the annular groove 34 of the seat rubber 10, so that the seat rubber 10 and the suspension component 44 are positioned in the front-back direction and in the lateral direction. In the present embodiment, since the outer circumferential surface of the projecting distal end portion of the center projecting part 28 constitutes the tapered guiding face 36, the center projecting part 28 is readily inserted into the positioning hole 48.

Furthermore, the reinforcing member 14 of the seat rubber 10 is arranged in the region away from the annular curving part 22 to the outer peripheral side. Thus, with the seat rubber 10 mounted onto the suspension component 44, the reinforcing member 14 is positioned around the riser part 50 of the suspension component 44. That is, the reinforcing member 14 is arranged at the position away from the riser part 50 to the outer peripheral side without overlapping the riser part 50 as viewed in the vertical direction.

Also, by the positioning pin 20 of the seat rubber 10 being inserted into a hole (not shown) provided to the receiving part 46 of the suspension component 44 as well, the seat rubber 10 and the suspension component 44 are configured to be positioned. Besides, the upper end of the riser part 50 is remote downward from the inner face of the bottom wall of the annular groove 34, thereby preventing damage to the rubber main body 12 due to contact by the riser part 50 as well as avoiding excessive restraint of the rubber main body 12.

A coil spring 52 is attached to the suspension component 44 onto which the seat rubber 10 is mounted. Specifically, the lower end of the coil spring 52 is arranged by being placed externally about the annular curving part 22 of the seat rubber 10, and the lower end of the coil spring 52 is overlapped on the contact face 24 constituted by the upper faces of the support part 18 of the outer peripheral plate-shaped part 16 and the annular curving part 22. The lower end of the coil spring 52 is vertically pressed against the receiving part 46 of the suspension component 44 while being placed externally about the riser part 50 of the suspension component 44. Accordingly, the annular curving part 22 is arranged between the coil spring 52 and the riser part 50, while the support part 18 of the seat rubber 10 is arranged between the coil spring 52 and the receiving part 46. With these arrangements, the lower end of the coil spring 52 is received by the suspension component 44 in cushioned fashion via the outer peripheral plate-shaped part 16 of the seat rubber 10.

The contact face 24 of the seat rubber 10, which is contacted by the lower end of the coil spring 52, extends in the circumferential direction with the width dimension corresponding to the diameter of the wire that constitutes the coil spring 52. Accordingly, the radially inner end of the reinforcing member 14 that is positioned between the radially inner end and the outer peripheral end of the contact face 24 overlaps the coil spring 52 as viewed in the vertical direction. Whereas the outer peripheral portion of the coil spring 52 is off the contact face 24 in FIG. 1, during input in the direction in which the coil spring 52 undergoes contraction, the lower face of the coil spring 52 may be in contact with the contact face 24 roughly over its entirety. Besides, in the present embodiment, the lower end of the coil spring 52 is inserted into the band part 26, so that the coil spring 52 is positioned with respect to the seat rubber 10.

In the mounted state onto the vehicle as described above, when vibration in the vertical direction is input from the coil spring 52 due to overriding the irregularities on the road surface during driving or the like, owing to elastic deformation of the rubber main body 12 of the seat rubber 10, desired cushioning action (vibration insulating action or the like) will be exhibited, thereby decreasing vibration transmission to the suspension component 44. In the present embodiment, the upper end of the riser part 50 of the suspension component 44 is vertically remote from the inner face of the bottom wall of the annular groove 34 of the seat rubber 10 without reaching there, as well as a gap is formed radially between the riser part 50 and the center projecting part 28 of the seat rubber 10. Thus, the elastic deformation of the rubber main body 12 is effectively allowed. Moreover, even if the inner circumferential surface of the riser part 50 and the outer circumferential surface of the center projecting part 28 come into close contact with each other due to the elastic deformation of the rubber main body 12, owing to the slot 38 formed on the outer circumferential surface of the center projecting part 28, the gap between the upper end of the riser part 50 and the inner face of the bottom wall of the annular groove 34 is configured to be kept in communication with the atmosphere without being sealed off.

Here, when downward force (acting force) is exerted from the coil spring 52, the acting force is configured to be dispersed by the seat rubber 10, so as to be transmitted to the suspension component 44 in a dispersed state. Specifically, when the downward force is exerted from the coil spring 52 on the contact face 24 of the seat rubber 10, the acting force is transmitted to the reinforcing member 14 of the seat rubber 10, and is dispersed roughly equally over the entire reinforcing member 14. Then, since the acting force is transmitted from the entire reinforcing member 14 to the suspension component 44, the acting force is dispersed and input over a wide area of the suspension component 44. By so doing, damage to the suspension component 44 due to concentrated action of stress is avoided, thereby improving durability of the suspension component 44.

Furthermore, the reinforcing member 14 has a flat-plate shape and is arranged so as to extend roughly orthogonally to the direction of input from the coil spring 52, whereby the reinforcing member 14 efficiently realizes the dispersion of the force. Moreover, the reinforcing member 14 is arranged so as to extend roughly parallel to the receiving part 46 of the suspension component 44. Thus, when the reinforcing member 14 and the receiving part 46 vertically approach each other due to input from the coil spring 52, stress concentration will be avoided.

Additionally, the reinforcing member 14 is placed at a position away from the annular curving part 22 of the rubber main body 12 to the outer peripheral side, so that the reinforcing member 14 is disposed radially outward without overlapping the riser part 50 of the suspension component 44 as viewed in the vertical direction. Therefore, in the case in which the downward force is input from the coil spring 52 to the seat rubber 10, the reinforcing member 14 of the seat rubber 10 and the riser part 50 of the suspension component 44 are prevented from locally approaching each other, thereby attaining dispersion of stress in the seat rubber 10 and the suspension component 44.

Moreover, the center projecting part 28 of the rubber main body 12 is inserted into the positioning hole 48 of the suspension component 44 and the riser part 50 of the suspension component 44 is inserted into the annular groove 34 of the rubber main body 12, so that the seat rubber 10 is positioned with respect to the suspension component 44 in the front-back direction and in the lateral direction. Therefore, the position of the reinforcing member 14 is less likely to deviate with respect to the suspension component 44, making it possible to prevent the reinforcing member 14 from being pressed against the suspension component 44 locally strongly due to the positioning deviation thereof.

Particularly in the present embodiment, the positioning pin 20 is provided to the outer peripheral plate-shaped part 16 of the rubber main body 12, and the positioning pin 20 is inserted into the hole (not shown) provided to the receiving part 46 of the suspension component 44, whereby the outer peripheral plate-shaped part 16 to which the reinforcing member 14 is bonded is positioned with respect to the suspension component 44. With this configuration, the positioning deviation of the reinforcing member 14 with respect to the suspension component 44 can be more effectively prevented, thereby avoiding stress concentration due to the positioning deviation.

Also, in the present embodiment, the radially inner end of the reinforcing member 14 overlaps the contact face 24 of the outer peripheral plate-shaped part 16 in the direction of action of the force from the coil spring 52. Accordingly, the acting force exerted from the coil spring 52 on the contact face 24 will be efficiently transmitted to the reinforcing member 14, thereby effectively exhibiting dispersion action of the force owing to the reinforcing member 14.

Besides, with the rubber thickness T on the side of the coil spring 52 from the reinforcing member 14 made greater, the input from the coil spring 52 will be sufficiently dispersed and moderated by the elasticity of the rubber, then be transmitted to the reinforcing member 14. This will improve load bearing capability of the reinforcing member 14, thereby lowering deformation rigidity required of the reinforcing member 14. Meanwhile, with the rubber thickness t on the side of the suspension component 44 from the reinforcing member 14 made smaller, it is possible to suppress the deformation of the reinforcing member 14 owing to the receiving part 46 of the suspension component 44, as well as to stably transmit the acting force, which is dispersed roughly equally over the entire reinforcing member 14, to the receiving part 46 in a dispersed state.

An embodiment of the present invention has been described in detail above, but the present invention is not limited to those specific descriptions. For example, no particular limitation is imposed as to the shapes of the outer periphery and the radial inside of the reinforcing member 14. That is, it would also be possible to adopt the reinforcing member of annular disk shape with its outer periphery and radial inside each being a rough circle, or alternatively to adopt the reinforcing member with its outer periphery and radial inside each being a rough polygon or the like. Moreover, the shapes of the outer periphery and the radial inside of the outer peripheral plate-shaped part 16, which is bonded to the reinforcing member 14, are not limited in particular either, but may be suitably changed according to the shape of the riser part 50 of the suspension component 44.

It is desirable that the reinforcing member 14 have a simple flat-plate shape with no irregularities throughout, but it is acceptable as long as the reinforcing member 14 can realize the dispersion of stress of the receiving part 46 due to the input from the coil spring 52. For example, the reinforcing member 14 may have a reinforced flat-plate shape that is able to obtain high deformation rigidity thereof by providing a reinforcing rib projecting upward at the outer peripheral edge that does not affect the dispersion of stress, or by providing a reinforcing rib at the site that is subjected to an especially large input from the coil spring 52, or the like.

Also, the reinforcing member 14 may be placed at the center in the vertical thickness direction in the support part 18 of the outer peripheral plate-shaped part 16, or may alternatively be placed at the position close to the coil spring 52, for example. That is, the thickness of the rubber arranged on the side of the coil spring 52 from the reinforcing member 14 may be equal to, or may alternatively be smaller than, the thickness of the rubber arranged on the side of the suspension component 44 from the reinforcing member 14.

Additionally, the positioning pin 20 for positioning the seat rubber 10 and the suspension component 44 with respect to each other is not essential.

Whereas the preceding embodiment illustrates an example in which the present invention is applied to a lower seat rubber that receives the lower end of the coil spring 52, the present invention can preferably be applied to an upper seat rubber that receives the upper end of the coil spring 52 as well.

What is claimed is:

1. A seat rubber configured to be mounted onto a suspension component, the suspension component including a receiving part of a coil spring, a positioning hole provided to a center of the receiving part, and a riser part being defined by a peripheral edge portion of the positioning hole gradually curving and rising in an annular shape toward an inside of the coil spring, while the seat rubber being configured to be overlapped on the receiving part and to receive the coil spring in cushioned fashion, the seat rubber comprising:
an outer peripheral plate-shaped part configured to extend along a surface of the receiving part and to receive an axial end of the coil spring;
an annular curving part defined by a radially inner portion of the outer peripheral plate-shaped part being configured to curve and rise along a surface of the riser part;
a center projecting part configured to be inserted into the positioning hole, the center projecting part being positioned radially inside the outer peripheral plate-shaped part and projecting from a rising distal end portion of the annular curving part toward a proximal end side thereof;
an annular groove provided between the annular curving part and the center projecting part while being configured to receive the riser part; and
a reinforcing member embedded and placed in the outer peripheral plate-shaped part with a flat-plate shape configured to be positioned around the riser part in a region away from the annular curving part to an outer peripheral side such that the reinforcing member disperses and transmits an input from the coil spring to the receiving part of the suspension component.

2. The seat rubber according to claim 1, wherein in a portion of the outer peripheral plate-shaped part configured to be contacted by the axial end of the coil spring, the reinforcing member is embedded at a position that is closer to a surface configured to be overlapped on the receiving part than a surface configured to be on a side of the coil spring in a thickness direction of the outer peripheral plate-shaped part.

3. The seat rubber according to claim 1, wherein the outer peripheral plate-shaped part includes a contact face configured to be contacted by the axial end of the coil spring, and a radially inner end of the reinforcing member is greater than a radially inner end of the contact face and is smaller than an outer peripheral end of the contact face.
